(19) United States
(12) Patent Application Publication
(10) Pub. No.: US 2001/0030666 A1
(43) Pub. Date: Oct. 18, 2001

(54) Computer-human interaction apparatus and interaction system

(75) Inventor: Kunikazu Okada, Tokyo (JP)

Correspondence Address: DARBY & DARBY, PROFESSIONAL CORPORATION, 805 THIRD AVENUE, NEW YORK, NY, 10022-7513, US

(73) Assignee: YUGEN GAISHA PERFORMANCE TECHNOLOGY, Tokyo (JP)

(21) Appl. No.: 09/836,714

(22) Filed: Apr. 17, 2001

(30) Foreign Application Priority Data
Apr. 17, 2000 (JP) 2000-115656

(51) Int. Cl. G06F 3/14

(52) U.S. Cl. 345/853; 345/764

(57) ABSTRACT

The present invention provides a displaying method, a display-processing device and a recording medium for organizing data, such as files and documents efficiently, so that the user can understand and maintain the organization easily. In the display-processing device in accordance with the present invention, each piece of data is endowed with a plurality (multi-dimensional) of hierarchical category attributes. The display-processing device displays the states of the hierarchical organization according to the respective category attributes by using tree style views indicating the corresponding hierarchical category attributes, side by side. Furthermore, when the user requests the system to display information with a combination of category attributes, by selecting one attribute from each tree view, the display processing device displays the list of requested information, such as the subject and the like of the data endowed with the selected category attributes.

### BACKGROUND OF THE INVENTION

1. Field of the Invention

The present invention relates to a method of displaying information regarding data having hierarchically organized category attributes, to a display-processing device using the displaying method, and to a recording medium on which programs for realizing the display-processing device are recorded.

Generally, when a computer records various types of free format data including binary files, such as programs, and text files, such as numerical information, in a recording section, such as a hard disk drive, data to be recorded is organized hierarchically. In addition, the computer endows category attributes (paths) displaying organized states to the data and records the data in the recording section.

The computer then displays the category hierarchy and organized states of the recorded data on a display section connected to the computer. For example, the computer displays the structure by using a tree-style view. According to the tree-style view, the user of the computer can understand the organized states.

The above-mentioned methods of recording and displaying hierarchically organized data are used as interfaces for a file system, that is, a fundamental function of an OS. In addition, the above-mentioned recording and reproducing methods are also used for a variety of software, such as an electronic mail user agent (client) application (hereafter referred to as an e-mail client) and a database applications.

FIG. 1 is an illustrative view showing an image displayed on the display section according to a conventional displaying method. FIG. 1 shows a state of displaying information regarding mails, that is, data, in an e-mail client. Various types of information in the e-mail client are displayed in three areas (left, upper right and lower right) partitioned by frames as shown in the figure.

The area in the left frame in the figure displays a tree-style view wherein some mail messages are organized hierarchically. In the example shown in the figure, a category attribute identified by a subject “Friend” has been selected by the user from among the category attributes (Contents) indicated by the tree-style view.

The area in the upper right frame in the figure displays a list of subjects and the information on mails having the selected category attributes. In the example shown in the figure, a mail with subject “Notice of class reunion” is selected from the list of pieces of mail by the user.

The area in the lower right frame displays the content of the selected mail. By viewing these frames, the user can understand the category attribute, subject and content of mail.

However, according to the development and widespread use of computers, the number of data in each category also increases acceleratingly. For this reason, in the conventional method of recording data endowed with category attributes and in the conventional method of displaying the hierarchical structure of the data one-dimensionally, the hierarchical structure becomes complicated, and the quantity of data having the same category attribute increases. Therefore, the user cannot easily understand the organized states of data.

### BRIEF SUMMARY OF THE INVENTION

The present invention is intended to solve the above-mentioned problems. In the present invention, each piece of data is endowed with a plurality (multi-dimensional) of category attributes, and the structures of the hierarchically organized category attributes are displayed by a plurally of tree-style views. By using these characteristics, the present invention is intended to provide a displaying method wherein the user can easily understand the data organization easily, to provide a display-processing device using the displaying method, and to provide a recording means on which programs for realizing the display-processing device are recorded.

The displaying method of the present invention comprises the steps of categorizing data according to a plurality of different hierarchical category attributes, and displaying the category hierarchy structures of these category attributes using a plurality of tree-style views, each indicating the hierarchical structures of a category attributes.

In a displaying method according to the first invention, each piece of data is endowed with a plurality of category attributes, for example, two kinds (plural kinds) of category attributes, that is, a first category attribute indicating the content of data, such as work, hobby, etc. and a second category attribute indicating the property of data, such as context of data, such as news, schedule, to-do or done, etc. Furthermore, in the displaying method according to the first invention, the respective organization states are displayed by a plurality of tree style views, each indicating the hierarchical levels corresponding thereto. Hence, the hierarchical data structure, which is apt to become complicated in a one-dimensional organization method, is prevented from becoming complicated. Furthermore, it increases the combination of category attributes substantially. Therefore, the hierarchical structure can be simplified. In addition, the quantity of data having the same category attribute can be reduced. As a result, the user can easily understand the data organization.

A displaying method according to a second invention is characterized in that the plural tree-style views are displayed, side by side.

In other words, in accordance with the second invention, the plural tree-style views are displayed, side by side. Hence, the user can understand the multi-dimensional hierarchical structure more easily.

A display-processing device according to a third invention comprises a recording section for recording data having hierarchically organized category attributes, a display section for displaying information regarding data recorded in said recording section, and a processor connected to said recording section and said display section, and capable of performing the following operations; said processor performs control so that pieces of data having a plurality of different category attributes are recorded in said recording section, and said processor performs control so that category hierarchy structures of the plural category attributes of said data are displayed as a plurality of tree style views, each indicating the structure of a category attribute.

A recording medium according to a fifth invention, capable of being read by computer, is provided with recorded programs for causing a computer equipped with a recording section for which records data with a plurality of hierarchically organized category attributes, and a display section. The recording medium capable of being read by computer is characterized in that the computer is caused to display the hierarchical structure of these category attributes as a plurality of tree style views, each indicating the structure of a category attribute.

A display-processing device according to a sixth invention comprises a recording section for recording data having hierarchically organized category attributes, a display section for displaying information regarding data recorded in said recording section, means for recording data having a plurality of different category attributes in said recording section, and means for displaying the hierarchical structure of these category attributes as a plurality of tree style views, each indicating the structure of a category.

In other words, in the display-processing device and the recording medium according to the third, fifth and sixth inventions, each piece of data is endowed with a plurality of category attributes. Hence, each piece of data is categorized by both the first hierarchical category attribute—content such as work hobby, etc, and the second hierarchical category attribute—context such as news, schedule, to-dos or done, etc. The structures of the hierarchically organized category attributes are displayed by a plurarily of tree style views. Hence, a hierarchical structure, which is apt to become complicated in a one-dimensional organization method, is prevented from becoming complicated. Furthermore, it increases the combination of category attributes substantially. Therefore, the hierarchical structure can be simplified. In addition, the quantity of data having the same category attribute can be reduced. As a result, the user can easily understand the hierarchical structure.

A display-processing device according to a fourth invention has the above-mentioned processor according to the third invention further performing the following operations; said processor receives a combination of category attributes each selected from among respective category as an input, said processor extracts data with category attributes corresponding to the input category selections from the data recorded in said recording section, and said processor displays information indicating the extracted data on said display section.

A display-processing device according to a seventh invention is the display-processing device according to the sixth invention, further comprising means for receiving a combination of category attributes each selected from among respective category as an input, means for extracting data with the input combination of category attributes from the data recorded in said recording section, and means for displaying indicating the extracted data on said display section.

In other words, by the display-processing devices according to the fourth and seventh inventions, information on the data with the selected category attributes are displayed in a list. Hence, the user can easily control data.

The above and further objects and features of the invention will more fully be apparent from the following detailed description with accompanying drawings.

### BRIEF DESCRIPTION OF THE SEVERAL VIEWS OF THE DRAWINGS

FIG. 1 is an illustrative view showing an image displayed on the display section according to the conventional displaying method;

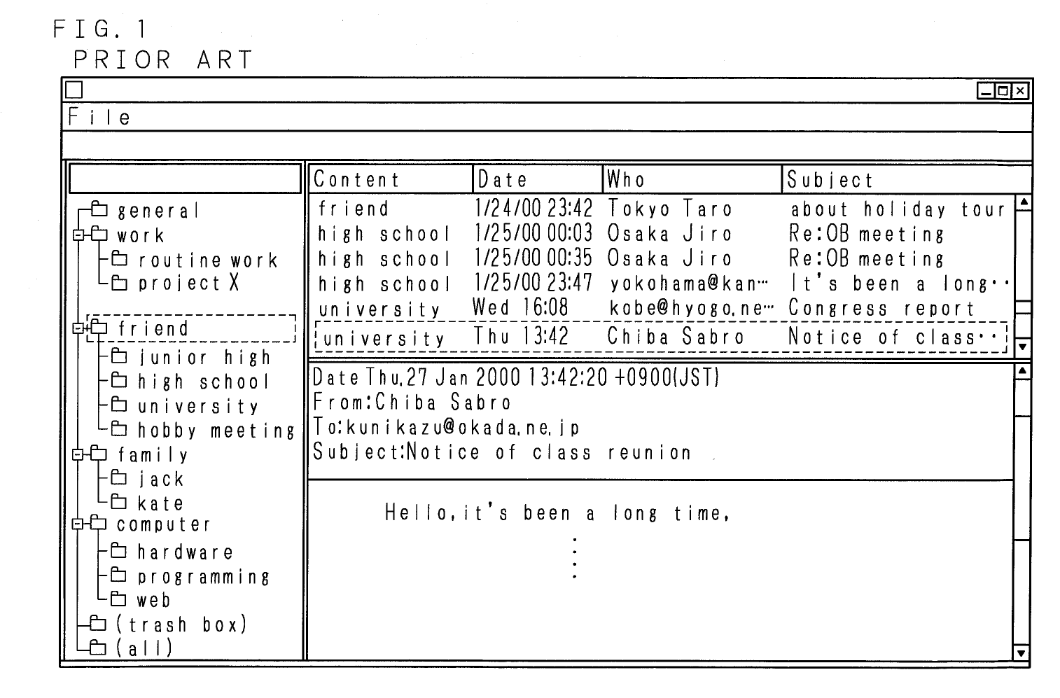

FIG. 2 is a block diagram showing a display-processing device according to the present invention;

FIG. 3 is a conceptually illustrative view showing the forms of data recorded in a recording section provided for the display-processing device of the present invention;

FIG. 4 is a flowchart showing the data recording process of the display-processing device of the present invention;

FIG. 5 is a flowchart showing the data displaying process of the display-processing device of the present invention; and

FIG. 6 is an illustrative view showing an image displayed on the display section according to the processing by the display-processing device of the present invention.

### DESCRIPTION OF THE PREFERRED EMBODIMENTS

The present invention will be described below referring to the accompanying drawings showing embodiments thereof.

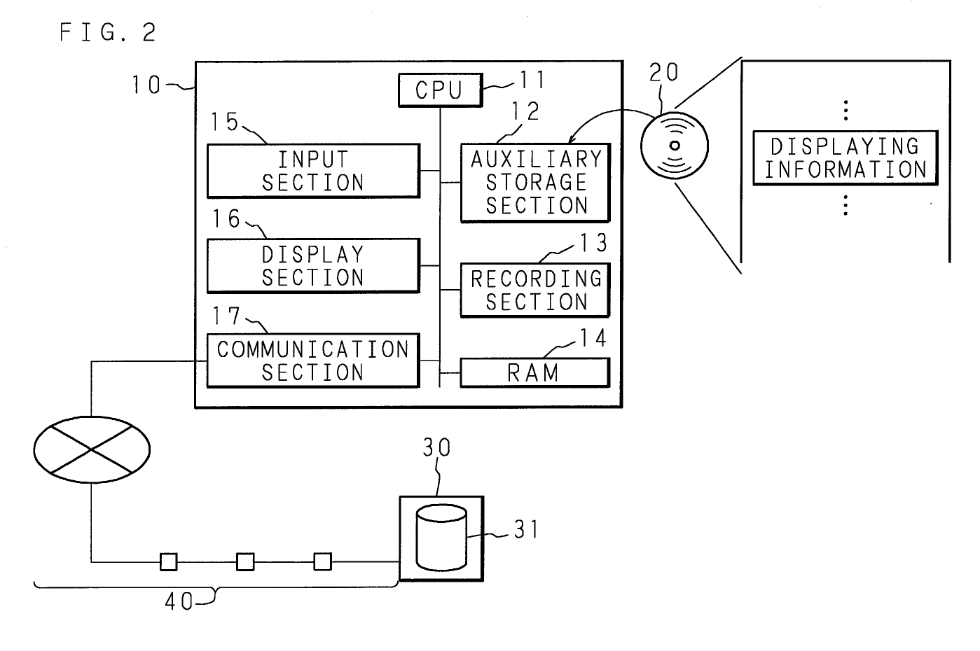

FIG. 2 is a block diagram showing a display-processing device according to the present invention. Numeral 10 in the figure designates the display-processing device according to the present invention in which a personal computer is used. The display-processing device 10 is equipped with an auxiliary storage section 12, such as a CD-ROM drive, for reading information, such as programs, from a recording medium 20, such as a CD-ROM disk, on which information, such as programs, for the display-processing device of the present invention has been recorded. In addition, the display-processing device 10 is equipped with a recording section 13, such as a hard disk drive, for recording the information, such as programs, read by the auxiliary storage section 12.

The information, such as programs, is read from the recording section 13 and stored in a RAM 14. Such programs are executed by a processor 11 (hereafter referred to as “a CPU (Central Processing Unit) 11). In this way, the personal computer operates as the display-processing device 10 of the present invention.

Data indicating various types of information including binary files, such as programs, text files, and numerical data, has been recorded in the recording section 13. The data is categorized according to a plurality of hierarchical category attributes. Each piece of the data is thus endowed with a plurality of category attributes indicating organized states. In other words, each piece of data is endowed with a plurality of category attributes, each having its own hierarchical category structure.

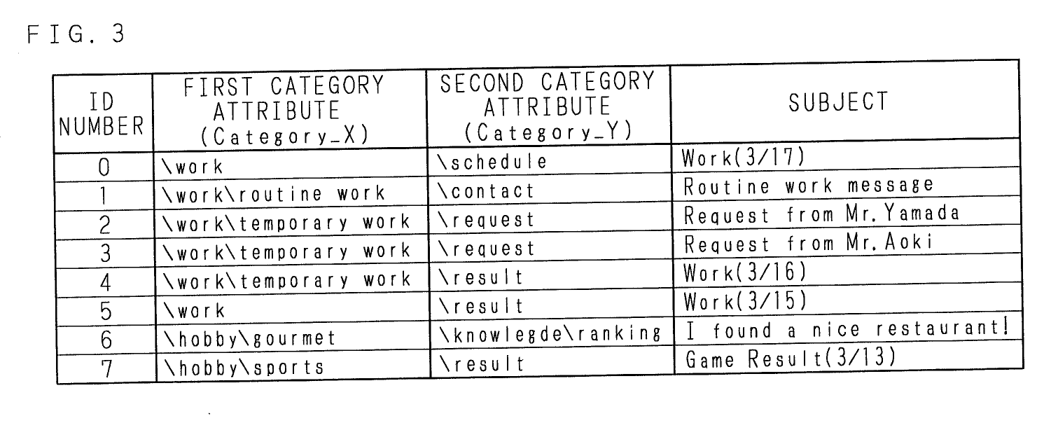

FIG. 3 is a conceptually illustrative view showing the forms of data recorded in the recording section 13 provided for the display-processing device 10 of the present invention. In FIG. 3, pieces of mail managed by an e-mail client are recorded as data. Each piece of data is endowed with an ID number identifying the piece of mail corresponding thereto, a first category attribute (Category_X) indicating the content of the mail, such as work, hobby, etc., a second category attribute (Category_Y) indicating the context of the mail, such as news, schedule, to-dos or done, and the subjects, and other data of the mail. Here, each category attribute is recorded as a “path” form, where category names of all hierarchical levels are concatenated from the top level to lower levels, with the separator symbol “/”.

Although two category attributes are shown in FIG. 3, the number of category attributes is not limited to two in the present invention. A piece of data should only be endowed with a plurality of category attributes. For example, the piece of data having an ID number “1” in the figure is endowed with “/Work/Routine work” as the first category attribute, and also endowed with “/Contact” as the second category attribute. In addition to these, the piece of data may be endowed with a category attribute regarding the year and month of recording of the piece of data, “/00/04,” as a third category attribute.

Furthermore, the display-processing device 10 is equipped with an input section 15, such as a keyboard and a mouse, a display section 16, such as a monitor, and a communication section 17. By using the communication section 17, the display-processing device 10 can be connected to a database server computer 30 via a communication network, such as the Internet. It may also be possible that the display-processing device 10 captures information, such as programs for the present invention, from the recording medium 31 of the database server computer 30 on which the information, such as the programs of the present invention, has been recorded, through the communication section 17 via transmission media 40, such as various types of relay devices, communication lines and carrier waves, and that the display-processing device 10 records the information in the recording section 13 and then executes such programs.

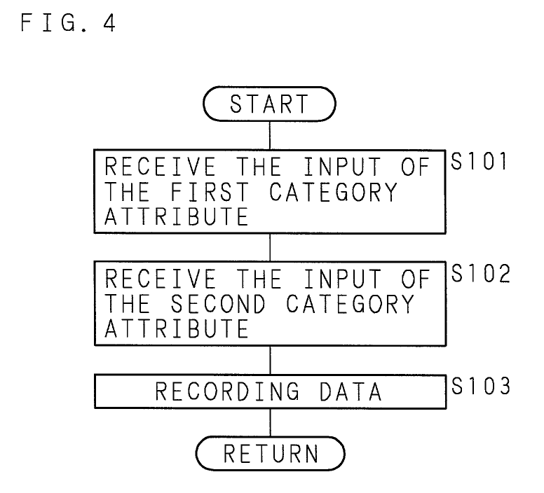

The data recording process of the display-processing device 10 of the present invention will be described next by using the flowchart shown in FIG. 4. The user of the display-processing device 10 inputs the category attributes of data to be recorded when the user desires to record data. In the following description, a case wherein each piece of data is endowed with two category attributes is explained as an example. When the number of category attributes are three or more, a process for one category attribute should only be repeated the number of times corresponding to the number of category attributes.

The display-processing device 10 receives the input of the first category attribute (at S101) and then receives the input of the second category attribute (at S102). Data endowed with the received first and second category attributes is recorded in the recording section 13 of the display-processing device 10 (at S103).

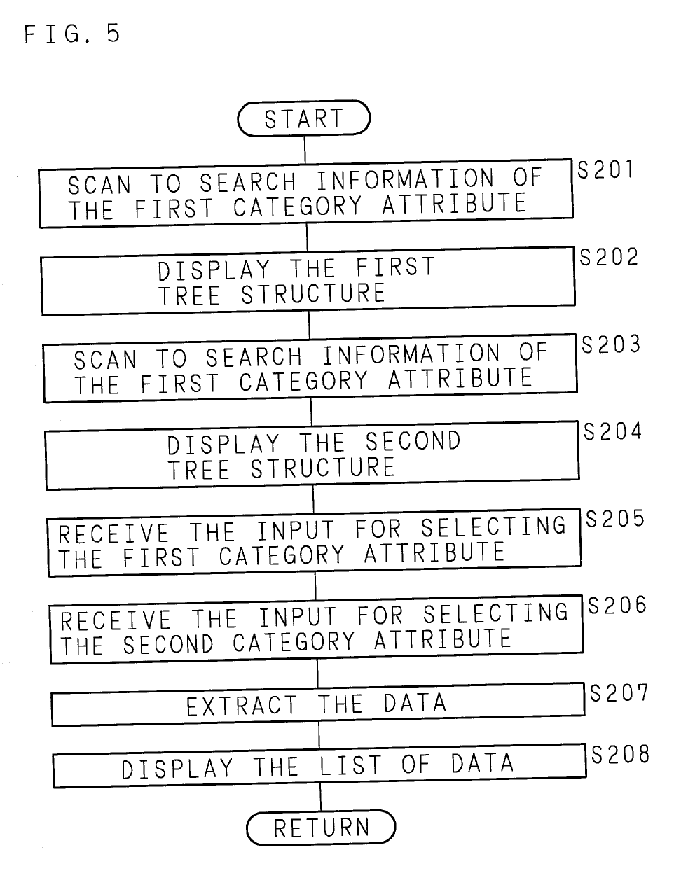

The data displaying process of the display-processing device 10 of the present invention will be described next by using the flowchart shown in FIG. 5. The display-processing device 10 scans the data recorded in the recording section 13 to search for information endowed with the first category attribute (at step S201). The display-processing device 10 displays a hierarchical structure found by the scanning as a first tree-style view on the display section 16 (at step S202). Furthermore, the display-processing device 10 carries out scanning to search for information endowed with the second category attribute (at step S203). The display-processing device 10 displays a hierarchical structure found by the scanning as a second tree-style view, together with the first tree-style view, side by side, (at step S204).

When the user desires to browse through data endowed with given category attributes, the user selects the given category attributes from the first and second category attributes, and inputs the attributes.

The display-processing device 10 receives the input for selecting the first category attribute (S205). The display-processing device 10 also receives the input for selecting the second category attribute (S206). The display-processing device 10 extracts pieces of data endowed with selected category attributes from the data recorded in the recording section 13 (at S207). Next, the display-processing device 10 displays the list of the extracted pieces of data, together with the first and second tree-style views, side by side (at S208).

When a category attribute having a higher level in the hierarchical structure is selected at step S205 and step S206, the display-processing device 10 extracts not only data directly endowed with the selected category attribute but also data endowed with category attributes having a lower level, indirectly included in the selected category attribute. When the category attribute having the highest level is selected, the display-processing device 10 extracts all the pieces of the data.

For example, among the pieces of data shown in FIG. 3, the pieces of data endowed with “\Work” as the first category attribute (Category_X) are those having ID numbers “0,” “1,” “2,” “3,” “4” and “5.” On the other hand, the pieces of data endowed with “\Result” as the second category attribute (Category_Y) are those having ID numbers “4,” “5” and “7.” Hence, when “\Work” and “\Result” are selected as the first and second category attributes, respectively, the pieces of data having ID numbers “4” and “5” are extracted.

When “\Work\Temporary work” is selected as the first category attribute at this time, only the piece of data having ID number “4” is extracted.

When a category attribute having a higher level in the hierarchical structure is selected as exemplified above, all the pieces of data corresponding to the category attribute, included directly and indirectly, are extracted. However, the condition of the extraction is not limited to this condition. For example, it is possible to use an extraction condition wherein only pieces of data directly corresponding to the category attribute are extracted, and pieces of data endowed with category attributes having a lower level are not extracted. In this way, various extraction conditions can be set in the present invention.

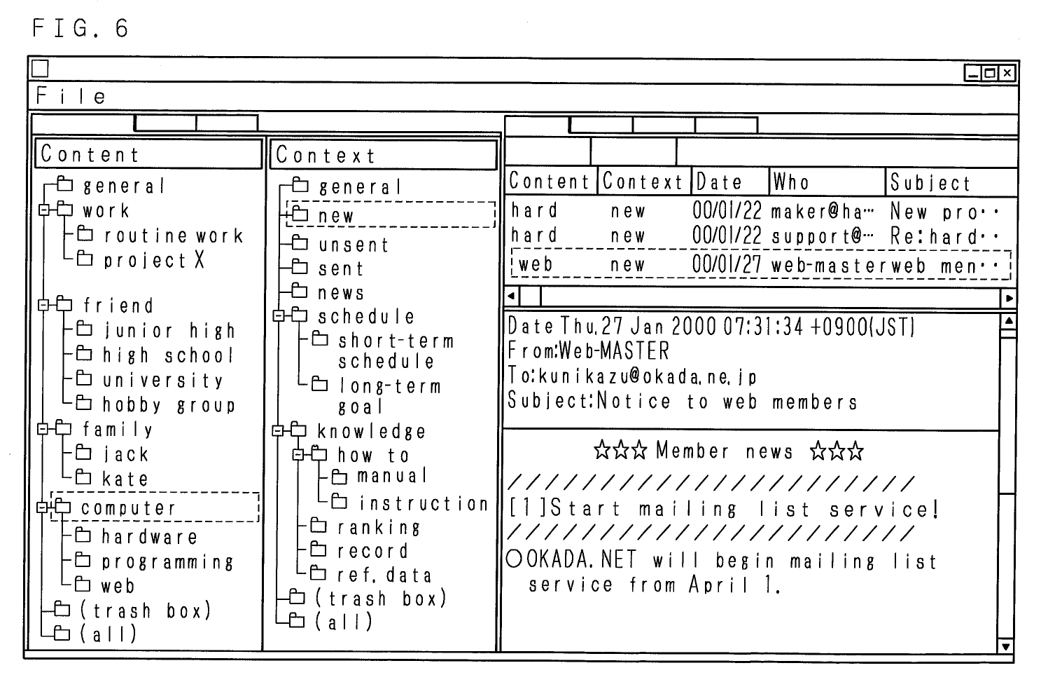

FIG. 6 is an illustrative view showing an image displayed on the display section 16 according to the processing by the display-processing device 10 of the present invention. FIG. 6 shows a state displaying information regarding mail, which is managed by a mail client application. Various types of information in the e-mail client are displayed in four areas (leftmost, second left, upper right and lower right) partitioned by frames as shown in the figure.

The area in the leftmost frame in the figure displays the first tree-style view which displays the structure of the first “Content” category. The figure shows a state where a content category named “computer” is selected by the user from among the content category tree.

At this time, not only pieces of data endowed with “Computer” as a category attribute but also pieces of data endowed with “Hardware,” “Programming” or “Web,” that is, category attributes that is sub-categories of “Computer,” would be selected.

The area in the second left frame in the figure displays a second tree-style view which displays the structure of the second “Content” category. The figure shows a state where a content category named “New” is selected by the user from among the content category tree.

The area in the upper right frame in the figure displays a list of the subjects and the like of mails with the selected first and second category attributes. The figure shows that a mail with subject “Notice to web members” is selected from the list of mails by the user.

The area in the lower right frame displays the content of the mail selected from the list in the upper right frame.

In the case when it is difficult to display a plurality of hierarchical structures on the same display screen simultaneously owing to limitations in the display section 16, such as the small size of its display screen, the display-processing device 10 carries out a process of switching the hierarchical structures to be displayed, in accordance with a predetermined operation. As a result, a plurality of hierarchical structures displayed side by side may be switched by the display-processing device 10. This corresponds, for example, to a case wherein an apparatus, such as a portable telephone, having a small display screen in the display section 16, is used as the display-processing device 10 of the present invention.

In the above-mentioned embodiment, pieces of mail, that is, pieces of data displayed by an e-mail client, are organized according to two category attributes. However, the present invention is not limited to this embodiment. As the interface of a file system, that is, a fundamental function of an OS, an embodiment wherein displayable files recorded in the recording section are displayed as data may also be applied. Furthermore, the present invention may also be applied to an embodiment wherein data recorded as database data by a database software program is displayed. Moreover, the present invention may also be applied to an embodiment wherein schedules (tasks) in a schedule management software program are displayed as data. In addition to these, the present invention can be applied to a variety of data control.

Furthermore, in the above-mentioned embodiment, a stand-alone apparatus is used as the display-processing device of the present invention. However, the present invention is not limited to this embodiment. An entire computer system comprising a plurality of apparatuses connected via a communication network may also be used as an embodiment. For example, pieces of data having hierarchical category attributes are controlled by a recording section provided for a database server computer. In addition, extraction and the like are controlled by a main server computer connected to the database server computer. Furthermore, display processing may be carried out by a display section provided for a client computer connected to the main server computer. Generally, this kind of embodiment can process more pieces of data than a stand-alone apparatus, and the present invention can be accomplished more effectively.

As described above, in the displaying method, the display-processing device and the recording medium according to the present invention, each piece of data is endowed with a plurality of category attributes, for example, two kinds (multi-dimensional) of category attributes, that is, a first category attribute indicating the content of data, such as work, hobby, etc. and a second category attribute indicating the context of data, such as news, schedule, to-do or done, etc. And a plurality of tree style views are displayed side by side. Hence, a hierarchical structure, which is apt to become complicated in a one-dimensional organization method, is prevented from becoming complicated. Furthermore, it increases the combination of category attributes substantially. Therefore, the hierarchical structure can be simplified, and the quantity of data having the same category attribute can be reduced. As a result, the user attempting to recognize the states displayed by the displaying method can easily understand the hierarchical structure.

Moreover, in the present invention, information, such as the subject and the like of the data having the category attributes selected by the user, is displayed in the form of a list for example, whereby the data can be controlled easily.

As this invention may be embodied in several forms without departing from the spirit of essential characteristics thereof, the present embodiment is therefore illustrative and not restrictive, since the scope of the invention is defined by the appended claims rather than by the description preceding them, and all change that fall within metes and bounds of the claims, or equivalence of such metes and bounds thereof are therefore intended to be embraced by the claims.

1. A displaying method comprising the steps of:
categorizing data according to a plurality of different hierarchical category attributes; and
displaying the category hierarchy structures of these category attributes using a plurality of tree-style views, each indicating the hierarchical structures of a category attributes.

2. A displaying method according to claim 1, wherein the plural tree-style views are displayed, side by side.

3. A display-processing device comprising:
a recording section for recording data having hierarchically organized category attributes;
a display section for displaying information regarding data recorded in said recording section; and
a processor connected to said recording section and said display section, and capable of performing the following operations;
said processor performs control so that pieces of data having a plurality of different category attributes are recorded in said recording section; and
said processor performs control so that category hierarchy structures of the plural category attributes of said data are displayed as a plurality of tree style views, each indicating the structure of a category attribute.

4. A display-processing device according to claim 3, wherein said processor further performs the following operations;
said processor receives a combination of category attributes each selected from among respective category as an input;
said processor extracts data with category attributes corresponding to the input category selections from the data recorded in said recording section; and
said processor displays information indicating the extracted data on said display section.

5. A recording medium capable of being read by computer and provided with recorded programs for causing a computer equipped with a recording section for which records data with a hierarchically organized category attributes, and a display section, wherein said computer is caused to display the hierarchical structure of these category attributes as a plurality of tree style views, each indicating the structure of a category attribute.

6. A display-processing device comprising:
a recording section for recording data having hierarchically organized category attributes;
a display section for displaying information regarding data recorded in said recording section;
means for recording data having a plurality of different category attributes in said recording section; and
means for displaying the hierarchical structure of these category attributes as a plurality of tree style views, each indicating the structure of a category.

7. A display-processing device according to claim 6, further comprising:
means for receiving a combination of category attributes each selected from among respective category as an input;
means for extracting data with the input combination of category attributes from the data recorded in said recording section; and
means for displaying indicating the extracted data on said display section.
